(19) United States
(12) Patent Application Publication
(10) Pub. No.: US 2004/0149685 A1
(43) Pub. Date: Aug. 5, 2004

(54) Method and product for electrically contacting oxide-coated conductors

(76) Inventors: Sabin Boily, Quebec (CA); Houshang Darvishi Alamdari, Quebec (CA)

Correspondence Address: FOLEY AND LARDNER, SUITE 500, 3000 K STREET NW, WASHINGTON, DC, 20007, US

(21) Appl. No.: 10/480,787

(22) PCT Filed: Mar. 20, 2002
(86) PCT No.: PCT/CA02/00913

(30) Foreign Application Priority Data
Jun. 15, 2001 (CA) 2,350,853

(51) Int. Cl. B44C 1/22

(52) U.S. Cl. 216/34

(57) ABSTRACT

The invention relates to an electrical bridging material in the form of a dispersion containing particles of an oxidation-resistant electrically conductive material and a dispersing medium, the particles having an average particle size ranging from about 0.1 μm to about 5 mm. Such a bridging material is useful for establishing electrical conductivity between two electrically conductive surfaces, at least one of the surfaces being covered with an oxide film. Alternatively, the particles can be used as a component of an electrical bridging member adapted to be disposed between the two electrically conductive surfaces for establishing electrical conductivity therebetween.

### TECHNICAL FIELD

The present invention pertains to improvements in the field of metal-metal electrical contacts. More particularly, the invention relates to a method of establishing electrical conductivity between two electrically conductive surfaces, at least one of which surfaces is covered with an oxide film.

### BACKGROUND ART

When two metal surfaces are brought in contact with one another, two major parameters influence the electrical contact resistance: the real contact area and the presence of surface oxide films. A metal surface is rarely flat and the real mechanical contact area is much smaller than the apparent contact surface. Depending on the pressure applied, the ductility and the surface roughness of the contact material, metal peaks on the surface deform until the force applied at the points of contact equals the counter-force exerted by the contact material. The contact points may consist of metal-metal contacts and/or metal-insulating oxide film-metal contacts. In order to decrease the electrical contact resistance, the insulating oxide films should be removed from the surface. Several chemical and mechanical methods exist for cleaning the contact surfaces. Sand blasting, brushing, ultrasonic cleaning and polishing are examples of mechanical cleaning methods typically used, whereas acid washing and electrochemical polishing are examples of the chemical cleaning methods used.

Surface cleaning improves the contact quality of those materials whose oxidation rate is slow, such as copper, silver, gold and palladium, which are widely used for good electric contacts. However, the electrical contact resistance of reactive metals such as aluminum cannot be improved by surface cleaning, since the oxides of these metals are created instantly even in normal environment. The oxide film on the surface of aluminum constitutes a very good electrically insulating film since it has a resistivity of about 10¹⁶ Ω-cm. This film is normally very thin (5-10 nm); however, in highly oxidizing environments, the film may have a thickness as high as 18 μm. The main factor adversely affecting the electrical resistance of aluminum contacts is this insulating oxide film. In order to decrease the electrical contact resistance of aluminum, this oxide film must be broken.

Several attempts have been made to increase the mechanical contact area of aluminum-aluminum contacts in order to decrease the electrical contact resistance. In some cases, a soft and ductile metal was used as between two aluminum electrodes. The ductile metal deforms easily when pressure is applied and fills the surface roughness of the electrodes, thereby increasing the mechanical contact area. For the same reason, conducting liquids and greases were applied between aluminum electrodes. However, the ductile metals and conducting liquids or greases do not penetrate the oxide film on the metal surface and the electrical resistance problem caused by surface oxide films still remains.

U.S. Pat. No. 5,527,591 discloses an electrical contact having solid conductive particles on the contact surface thereof. The particles are of greater hardness than that of the contact material to deform the contact material and cause breakage or fracture of the oxide film on a mating contact surface. The particles are applied to the contact surface by a technique which results in the particles being intimately bonded to the contact surface. Examples of such techniques include hypervelocity oxygen fuel spraying and plasma spraying. These techniques are not only costly and require special equipment, but also result in permanent bonding of the particles to the contact surface. Thus, they cannot be used in the case where the contact surface cannot be permanently modified or when the electrical contacts need to be assembled and disassembled several times. The electrical contact between busbars and consumable anode assemblies in aluminum reduction cells is such an example.

U.S. Pat. No. 5,741,430 discloses a heat-curable conductive adhesive for electrical circuit connections, which contains hard conductive particles adapted to pierce through the aforesaid oxide film. Such a type of adhesive is designed for a single use in electrical circuit assemblies that are not disassembled during their useful life and thus suffers from the same drawback as discussed above in respect of U.S. Pat. No. 5,527,591. For example, in the case of electrical contacts between busbars and consumable anodes in aluminum reduction cells, the contact surfaces periodically move against each other and this movement cannot be accommodated by an adhesive.

### DISCLOSURE OF THE INVENTION

It is therefore an object of the present invention to overcome the above drawback and to provide a method of establishing electrical conductivity between two electrically conductive surfaces, at least one of which surfaces is covered with an oxide film, using hard conductive particles in a manner such that the particles do not become permanently bonded to conductive surface(s).

According to one aspect of the invention, there is thus provided a method of establishing electrical conductivity between two electrically conductive surfaces, at least one of the surfaces being covered with an oxide film. The method of the invention comprises the steps of:

a) providing between the surfaces a dispersion containing particles of an oxidation-resistant electrically conductive material and a dispersing medium, the particles having an average particle size ranging from about 0.1 μm to about 5 mm; and

b) bringing the surfaces with the dispersion therebetween in close proximity to one another so as to cause the particles to break the oxide film and to partially penetrate both surfaces, whereby electrical conductivity between the two surfaces is established through the particles.

The use of a dispersion containing the aforesaid particles enables one to dispose the particles between the two conductive surfaces, without the particles becoming permanently bonded. The dispersion can be easily applied onto the oxide film or onto the other conductive surface with a spatula or other simple instrument. If required, the dispersion can also be easily removed when the surfaces are separated from one another. The dispersing medium can be chosen to act as a seal between the two surfaces, thereby preventing oxidizing or otherwise corrosive gases as well as dust from entering between the surfaces through interstices. The gases and dust are thus prevented from chemically attacking the conductive surfaces and diminishing their electrical conductivity.

The particles which are present in the dispersion and used to break the oxide film and partially penetrate both conductive surfaces when these surfaces are brought in close proximity to one another have an average particle size ranging from about 0.1 μm to about 5 mm. If the particles have an average particle size less than 0.1 μm, they are two small to break the oxide film. Particles having an average particle size greater than 5 mm, on the other hand, are too large to adequately penetrate the electrically conductive surfaces. Preferably, the particles have an average particle size ranging from about 5 μm to about 150 μm.

Examples of suitable oxidation-resistant electrically conductive materials of which the particles can be made include tungsten, tungsten carbide, titanium diboride, hardened steel and beryllium-copper alloy. Tungsten and tungsten carbide are preferred.

According to a preferred embodiment, the dispersing medium comprises a grease. Examples of suitable greases which can be used include petroleum-based greases and silicone-based greases. Use is preferably made of a silicone-based grease formed of a polydimethylsiloxane having a viscosity between 100 and 100,000 cSt at 25° C., in admixture with a thickening agent such as fumed silica. Preferably, the silicone-based grease comprises 90 to 97 weight % of polydimethylsiloxane having a viscosity between 100 and 1,000 cSt at 25° C., and 3 to 10 weight % of thickening agent.

In a particularly preferred embodiment, the dispersion contains 5 to 55 weight % of the aforesaid particles and 45 to 95 weight % of the aforesaid grease. A preferred dispersion contains about 30 weight % of particles and about 70 weight % of grease.

The aforesaid dispersion which is used to bridge the two electrically conductive surfaces and to establish electrical conductivity therebetween constitute another aspect of the invention.

The present invention therefore provides, in another aspect thereof, an electrical bridging material in the form of a dispersion for use in establishing electrical conductivity between two electrically conductive surfaces, at least one of the surfaces being covered with an oxide film. The dispersion particles of an oxidation-resistant electrically conductive material and a dispersing medium, the particles having an average size ranging from about 0.1 μm to about to 5 mm.

The aforementioned particles can also be used as a component of an electrical bridging element adapted to be disposed between the two electrically conductive surfaces for establishing electrical conductivity therebetween.

According to a further aspect of the invention, there is thus provided a method of establishing electrical conductivity between two electrically-conductive surfaces, one of the surfaces being covered with an oxide film. The method comprises the steps of:

a) providing an electrical bridging member having an electrically conductive body, first and second surfaces facing opposite directions and a layer of particles on the first surface, the particles being formed of an oxidation-resistant electrically conductive material and having an average size ranging from about 0.1 μm to about 5 mm;

b) disposing the electrical bridging member between the electrically conductive surfaces in a manner such that the first surface of the member faces the aforesaid one electrically conductive surface and the second surface of the member faces the other electrically conductive surface; and

c) bringing the electrically conductive surfaces in proximity to one another so as to cause the particles on the first surface to break the oxide film and to partially penetrate the aforesaid one electrically conductive surface, and cause the second surface and the other electrically conductive surface to contact one another, whereby electrical conductivity between the two electrically conductive surfaces is established through the particles and the electrically conductive body.

According to still another aspect of the invention, there is provided a method of establishing electrical conductivity between two electrically conductive surfaces each covered with an oxide film. The method comprises the steps of:

a) providing an electrical bridging member having an electrically conductive body, first and second surfaces facing opposite directions, a first layer of particles on the first surface and a second layer of particles on the second surface, the particles being formed of an oxidation-resistant electrically conductive material and having an average size ranging from about 0.1 μm to about 5 mm;

b) disposing the electrical bridging member between the electrically conductive surfaces in a manner such that the first surface of the member faces one of said electrically conductive surfaces and the second surface of the member faces the other electrically conductive surface; and

c) bringing the electrically conductive surfaces in proximity to one another so as to cause the particles on the first surface to break the oxide film on the aforesaid one electrically conductive surface and to partially penetrate the aforesaid one electrically conductive surface, and cause the particles on the second surface to break the oxide film on the other electrically conductive surface and to partially penetrate the other electrically conductive surface, whereby the electrical conductivity between the two electrically conductive surfaces is established through the particles of the first and second layers on the member and the electrically conductive body.

The body of the electrical bridging member can be formed of a metal selected from the group consisting of Cu, Al, Au, Ag, Fe, Pd, Co, Ni, Ti, Mg, Zn, Sn, Ru and Cd. Preferably, the body is in the form of a foil and the particles partially penetrate the foil.

Where use is made of an electrical bridging member having two layers of particles thereon, the body of such a member is preferably formed of a metal or metal alloy matrix having dispersed therein particles of the same oxidation-resistant electrically conductive material as the particles of the first and second layers, the dispersed particles having the aforesaid average size. For example, the matrix can comprise a metal selected from the group consisting of Cu, Fe, Al, Ag, Pd, Ni, Au, Co, Ti, Mg, Zn, Sn, Ru and Cd. Examples of suitable metal alloy, on the other hand, include aluminum-based alloys and copper-based alloys.

The above electrical bridging member having a body formed of a metal or metal alloy matrix with dispersed particles can be used not only for establishing electrical conductivity between two electrically conductive surfaces each covered with an oxide film, but also for establishing electrical conductivity between two electrically conductive surfaces; where only one of the surfaces is covered with an oxide film.

According to yet another aspect of the invention, there is thus provided a method of establishing electrical conductivity between two electrically conductive surfaces, one of the surfaces being covered with an oxide film, the method comprises the steps of:

a) providing an electrical bridging member having an electrically conductive body formed of a metal or metal alloy matrix having dispersed therein particles of an oxidation-resistant electrically conductive material, first and second surfaces facing opposite directions, a first layer of particles of the same material on the first surface and a second layer of particles of the same material on the second surface, the particles having an average size ranging from about 0.1 μm to about 5 mm;

b) disposing the electrical bridging member between the electrically conductive surfaces in a manner such that the first surface of the member faces the aforesaid one electrically conductive surface and the second surface of the member faces the other electrically conductive surface; and

c) bringing the electrically conductive surfaces in proximity to one another so as to cause the particles on the first surface to break the oxide film and to partially penetrate the aforesaid one electrically conductive surface, and cause the particles on the second surface to partially penetrate the other electrically conductive surface, whereby electrical conductivity between the two electrically conductive surfaces is established through the particles of the first and second layers on the member and the electrically conductive body.

The aforementioned electrical bridging member which is used for establishing electrical conductivity between two electrically conductive surfaces, at least one of the surfaces being covered with an oxide film, also constitutes a further aspect of the invention.

According to still a further aspect of the invention, there is thus provided an electrical bridging member for use in establishing electrical conductivity between two electrically conductive surfaces, at least one of the surfaces being coated with an oxide film. The bridging member has an electrically conductive body, first and second surfaces facing opposite directions, and a first layer of particles on the first surface, the particles being formed of an oxidation-resistant electrically conductive material and having an average size ranging from about 0.1 μm to about 5 mm.

Preferably, the electrical bridging member further includes a second layer of the aforesaid particles on the second surface.

As previously indicated, the body of the bridging member can be in the form of a foil, the aforesaid particles partially penetrating the foil. The body can also be formed of a metal or metal alloy matrix having dispersed therein particles of the same oxidation-resistant electrically conductive material as the particles of the first and second layers, the dispersed particles having the aforesaid average size.

The present invention is particularly useful for establishing electrical conductivity between two electrically conductive surfaces, where a high density current is passed through the surfaces and the insulating oxide film on either surface or on both surfaces causes a significant energy loss. An example of application of the electrical bridging material or bridging member according to the invention is in the aluminum production smelting cells where a current having a density of about 30 A/cm² passes through aluminum contacts between anodes and busbars and the surface oxide film on each electrode causes a voltage drop of 10 to 100 mV, which represents a significant energy loss. Another example of application is in the electric transport lines where aluminum contacts are used to join the lines to each other.

### DESCRIPTION OF DRAWINGS

Further features and advantages of the invention will become more readily apparent from the following description of preferred embodiments illustrated by way of example in the accompanying drawings, in which:

FIGS. 1A and 1B are schematic sectional views illustrating two electrical contacts having therebetween a layer of electrical bridging material according to a preferred embodiment of the invention, before and after assembly of the contacts;

FIG. 2 is a schematic sectional view illustrating an electrical bridging member according to a preferred embodiment of the invention;

FIG. 3 is a schematic sectional view illustrating the electrical bridging member shown in FIG. 2, disposed between two electrical contacts;.

FIG. 4 is a schematic sectional view illustrating an electrical bridging member according to another preferred embodiment of the invention;

FIG. 5 is a schematic sectional view illustrating the electrical bridging member shown in FIG. 4, disposed between two electrical contacts;

FIG. 6 is a schematic sectional view illustrating an electrical bridging member according to a further preferred embodiment of the invention; and

FIG. 7 is a schematic sectional view illustrating the electrical bridging member shown in FIG. 6, disposed between two electrical contacts.

### MODES FOR CARRYING OUT THE INVENTION

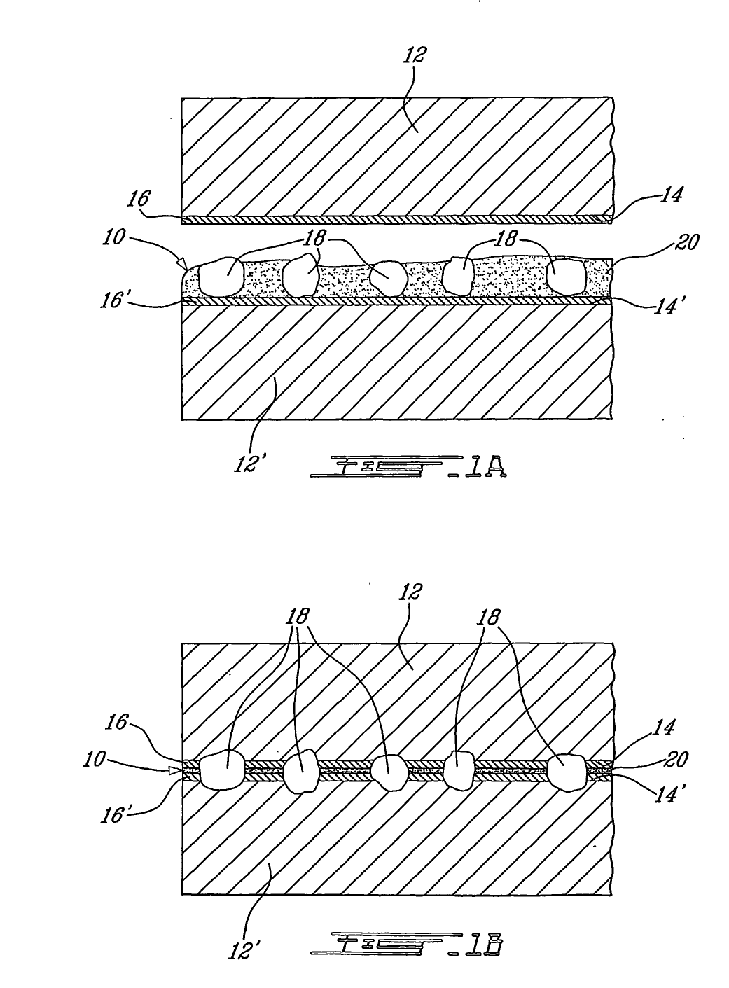

Referring first to FIG. 1A, there is illustrated an electrical bridging material 10 provided between two electrical contacts 12,12′, for establishing electrical conductivity therebetween. The contacts 12 and 12′ have respective surfaces 14 and 14′ covered with oxide films 16 and 16′. The bridging material 10 is in the form of a dispersion containing particles 18 of an oxidation-resistant electrically conductive material such as tungsten, and a dispersing medium 20 consisting of a grease such as a silicone-based grease. As shown in FIG. 1B, when the two contacts 12,12′ are brought in close proximity to one another, the particles 18 break the oxide films 16,16′ and partially penetrate the contact surfaces 14,14′, thereby establishing electrical conductivity between the contacts 12 and 12′. The electrical bridging material 10 can also be used for establishing electrical conductivity between two electrical contacts, where only one of the contact surfaces is covered with an oxide film.

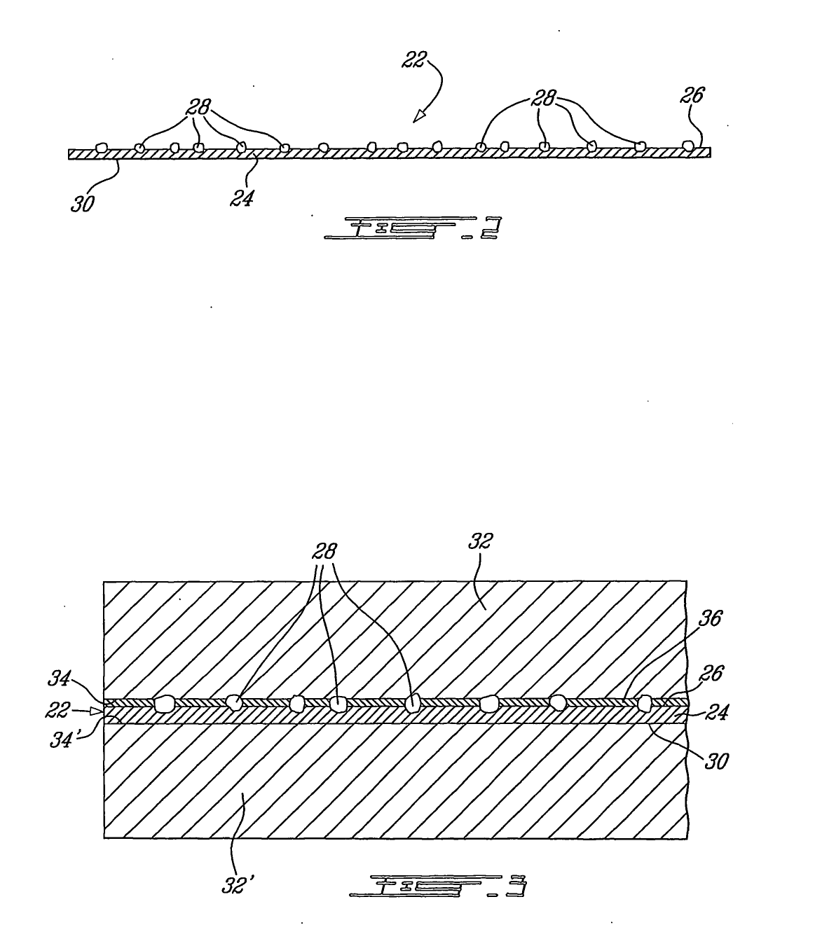

FIG. 2 illustrates an electrical bridging member 22 comprising an electrically conductive body 24 in the form of a foil having on its surface 26 a layer of particles 28. The particles 28 are formed of an oxidation-resistant electrically conductive material such as tungsten carbide and partially penetrate the foil surface 26. They can be cold welded to the foil 24 by the application of pressure. The other surface 30 of the foil 24 is unaltered.

As shown in FIG. 3, the electrical bridging member 22 is used for establishing electrical conductivity between two electrical contacts 32,32′ having respective surfaces 34,34′, where only the surface 34 is covered with an oxide film 36. The bridging member 22 is disposed between the contacts 32 and 32′ in a manner such that the foil surface 26 faces the oxide film 36 and the other foil surface 30 faces the contact surface 34′. The contacts 32,32′ are thereafter brought in proximity to one another so as to cause the particles 28 to break the oxide film 36 and to partially penetrate the contact surface 34 and cause the foil surface 30 and the contact surface 34′ to contact one another. Electrical conductivity between the contacts 32,32′ is thus established through the foil 24 and the particles 28.

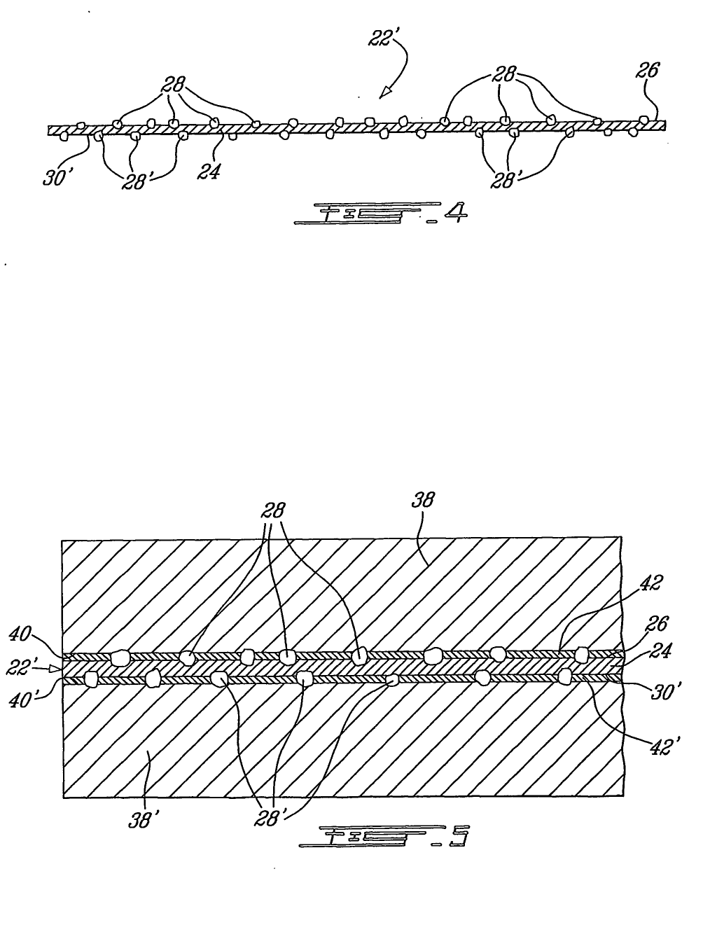

FIG. 4 illustrates an electrical bridging member 22′ which is similar to the bridging member 22 shown in FIG. 2, with the exception that a layer of particles 28′ is provided on the foil surface 30′. The particles 28′ are formed of the same oxidation-resistant electrically conductive material as the particles 28 and have the same particle size.

As shown in FIG. 5, the electrical bridging member 22′ is used for establishing electrical conductivity between two electrical contacts 38,38′ having respective surfaces 40,40′ covered with oxide films 42,42′. The bridging member 22′ is disposed between the contacts 38 and 38′ in a manner such that the foil surface 26 faces the oxide film 42 and the other foil surface 30′ faces the oxide film 42′. The contacts 38,38′ are thereafter brought in proximity to one another so as to cause the particles 28 to break the oxide film 42 and to partially penetrate the contact surface 40, and cause the particles 28′ to break the oxide film 42′ and partially penetrate the contact surface 40′. Electrical conductivity between the contacts 38,38′ is thus established through the foil 24 and the particles 28,28′.

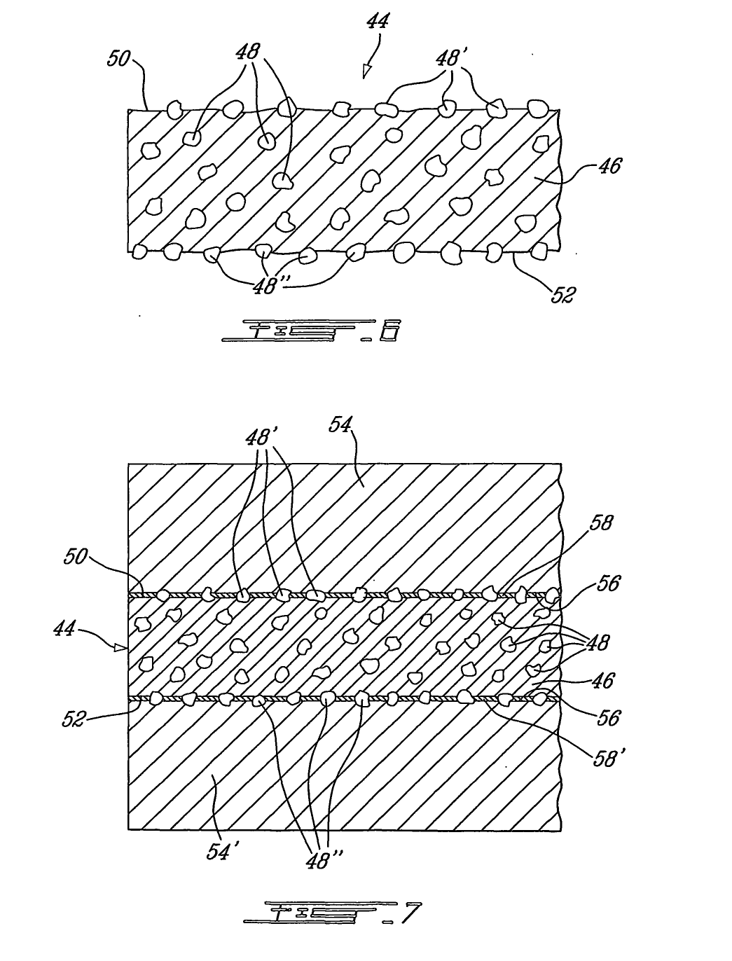

FIG. 6 illustrates another type of electrical bridging member 44 for establishing electrical conductivity between two electrical contacts. The bridging member 44 has an electrically conductive body 46 formed of a metal or metal alloy matrix having dispersed therein particles 48 of an oxidation-resistant electrically conductive material such as tungsten carbide, with a layer of particles 48′ projecting from the surface 50 of the body 46 and a layer of particles 48″ projecting from the other surface 52. The particles 48′ and 48″ are formed of the same oxidation-resistant electrically conductive material as the particles 48 and have the same particle size.

As shown in FIG. 7, the electrical bridging member 44′ is used for establishing electrical conductivity between two electrical contacts 54,54′ having respective surfaces 56,56′ covered with oxide films 58,58′. The bridging member 44′ is disposed between the contacts 54 and 54′ in a manner such that the surface 50 faces the oxide film 58 and the surface 52′ faces the oxide film 58′. The contacts 54,54′ are thereafter brought in proximity to one another so as to cause the particles 48′ to break the oxide film 58 and to partially penetrate the contact surface 56, and cause the particles 48″ to break the oxide film 58′ and partially penetrate the contact surface 56. Electrical conductivity between the contacts 54,54′ is thus established through the body 46 and the particles 48, 48′ and 48″. The electrical bridging member 44 can also be used for establishing electrical conductivity between two electrical contacts, where only one contact surface is covered with an oxide film.

The following non-limiting examples illustrate the invention.

### EXAMPLE 1

A dispersion containing tungsten particles and a silicone-based grease as a dispersing medium was prepared. The silicone-based grease was obtained by mixing 95 weight % of a polydimethylsiloxane having a viscosity of about 1,000 cSt at 25° C. with 5 weight % of fumed silica. 30 weight % of tungsten powder having an average particle size of about 45 μm were mixed with 70 weight % of the silicone-based grease. The resulting dispersion was used as an electrical bridging material between two oxidized aluminum electrodes. Each anodized electrode had on its surface an aluminum oxide film with a thickness of 18 μm. These electrodes, because of the thick aluminum oxide films, are highly insulating so that they are practically in open circuit when a potential of 40V is applied. By applying a layer of the dispersion onto the surface oxide film of either electrode and applying a pressure of 6 MPa to bring the electrodes in close proximity to one another, the oxide films were broken by the particles and a current density of 30 A/cm² and a voltage drop of 500 mV were established.

### EXAMPLE 2

A metal foil with tungsten carbide particles on both surfaces thereof was prepared. A copper foil having a thickness of 200 μm and tungsten carbide powder having an average particle size of about 100 μm were used. The copper foil was sandwiched between a layer of tungsten carbide powder and an aluminum foil on both sides to form a sandwich comprising the following five layers: aluminum foil/tungsten carbide powder/copper foil/tungsten carbide powder/aluminum foil. The resulting sandwich was then rolled under pressure so as to cause the tungsten carbide particles to partially penetrate the copper foil. The outer aluminum foils were then removed from the sandwich. The copper foil with the tungsten carbide particles on both surfaces thereof was then cut and used as an electrical bridging member for establishing electrical conductivity between two aluminum electrodes.

### EXAMPLE 3

A metal matrix composite with a matrix of aluminum containing 20 vol. % of tungsten carbide particles was prepared by powder metallurgy. 20 vol. % of tungsten carbide powder having an average particle size of about 100 μm were added to 80 vol. % of aluminum powder, mixed in a V-blender and cold pressed under a uniaxial pressure of 200 MPa using a hardened steel die. The pressed green compact was then sintered at 610° C. for 30 minutes and furnace cooled. The sintered composite was then cut, grinded and used as an electrical bridging member for establishing electrical conductivity between two aluminum electrodes.

1. A method of establishing electrical conductivity between two electrically conductive surfaces, at least one of said surfaces being covered with an oxide film, said method comprising the steps of:
a) providing between said surfaces a non-adhesive dispersion containing particles of an oxidation-resistant electrically conductive material and a dispersing medium, said particles having an average particle size ranging from about 0.1 μm to about 5 mm; and
b) bringing said surfaces with said dispersion therebetween in close proximity to one another so as to cause said particles to break said oxide film and to partially penetrate both said surfaces, whereby said electrical conductivity is established through said particles.

2. A method according to claim 1, wherein said particles have an average particle size ranging from about 5 μm to about 150 μm.

3. A method according to claim 1 or 2, wherein said oxidation-resistant electrically conductive material is selected from the group consisting of tungsten, tungsten carbide, titanium diboride, hardened steel and beryllium-copper alloy.

4. A method according to claim 1, wherein said oxidation-resistant electrically conductive material is tungsten.

5. A method according to any one of claims 1 to 4, wherein said dispersing medium comprises a grease selected from the group consisting of petroleum-based greases and silicone-based greases.

6. A method according to claim 5, wherein said grease is a silicone-based grease formed of polydimethylsiloxane having a viscosity between 100 and 100,000 cSt at 25° C., in admixture with a thickening agent.

7. A method according to claim 6, wherein said silicone-based grease comprises 90 to 97 weight % of polydimethylsiloxane having a viscosity between 100 and 1,000 cSt at 25° C., and 3 to 10 weight % of thickening agent.

8. A method according to claim 7, wherein said silicone-based grease comprises about 95 weight % of polydimethylsiloxane having a viscosity of about 1,000 cSt at 25° C., and about 5 weight % of thickening agent, and wherein said thickening agent is fumed silica.

9. A method according to any one of claims 5 to 8, wherein said dispersion contains 5 to 55 weight % of said particles and 45 to 95 weight % of said grease.

10. A method according to claim 9, wherein said dispersion contains 30 weight % of said particles and 70 weight % of said grease.

11. A method of establishing electrical conductivity between two electrically conductive surfaces, one of said surfaces being covered with an oxide film, said method comprising the steps of:
a) providing an electrical bridging member having a non-adhering electrically conductive body, first and second surfaces facing opposite directions and a layer of particles on said first surface, said particles being formed of an oxidation-resistant electrically conductive material and having an average particle size ranging from about 0.1 μm to about 5 mm;
b) disposing said electrical bridging member between said electrically conductive surfaces in a manner such that said first surface faces said one electrically conductive surface and said second surface faces the other of said electrically conductive surfaces; and
c) bringing said electrically conductive surfaces in proximity to one another so as to cause the particles on said first surface to break said oxide film and to partially penetrate said one electrically conductive surface, and cause said second surface and said other electrically conductive surface to contact one another, whereby said electrical conductivity is established through said particles and said electrically conductive body.

12. A method according to claim 11, wherein said particles have an average particle size ranging from about 5 μm to about 150 μm.

13. A method according to claim 11 or 12, wherein said oxidation-resistant electrically conductive material is selected from the group consisting of tungsten, tungsten carbide, titanium diboride, hardened steel and beryllium-copper alloy.

14. A method according to claim 13, wherein said oxidation-resistant electrically conductive material is tungsten carbide.

15. A method according to any one of claims 11 to 14, wherein the body of said electrical bridging member is formed of a metal selected from the group consisting of Cu, Al, Au, Ag, Fe, Pd, Co, Ni, Ti, Mg, Zn, Sn, Ru and Cd.

16. A method according to claim 15, wherein said body is in the form of a foil, and wherein said particles partially penetrate said foil.

17. A method of establishing electrical conductivity between two electrically conductive surfaces, one of said surfaces being covered with an oxide film, said method comprising the steps of:
a) providing an electrical bridging member having a non-adhering electrically conductive body formed of a metal or metal alloy matrix having dispersed therein particles of an oxidation-resistant electrically conductive material, first and second surfaces facing opposite directions, a first layer of said particles on said first surface and a second layer of said particles on said second surface, said particles having an average particle size ranging from about 0.1 μm to about 5 mm;
b) disposing said electrical bridging member between said electrically conductive surfaces in a manner such that said first surface faces said one electrically conductive surface and said second surface faces the other of said electrically conductive surfaces; and
c) bringing said electrically conductive surfaces in proximity to one another so as to cause the particles on said first surface to break said oxide film and to partially penetrate said one electrically conductive surface, and cause the particles on said second surface to partially penetrate said other electrically conductive surface, whereby said electrical conductivity is established through the particles of said first and second layers and said electrically conductive body.

18. A method according to claim 17, wherein said particles have an average particle size ranging from about 5 μm to about 150 μm.

19. A method according to claim 17 or 18, wherein said oxidation-resistant electrically conductive material is selected from the group consisting of tungsten, tungsten carbide, titanium diboride hardened steel and beryllium-copper alloy.

20. A method according to claim 19, wherein said oxidation-resistant electrically conductive material is tungsten carbide.

21. A method according to any one of claims 17 to 20, wherein said matrix comprises a metal selected from the group consisting of Cu, Fe, Al, Ag, Pd, Ni, Au, Co, Ti, Mg, Zn, Sn, Ru and Cd.

22. A method of establishing electrical conductivity between two electrically conductive surfaces each covered with an oxide film, said method comprising the steps of:
a) providing an electrical bridging member having a non-adhering electrically conductive body, first and second surfaces facing opposite directions, a first layer of particles on said first surface and a second layer of particles on said second surface, said particles being formed of an oxidation-resistant electrically conductive material and having an average particle size ranging from about 0.1 μm to about 5 mm;
b) disposing said electrical bridging member between said electrically conductive surfaces in a manner such that said first surface faces one of said electrically conductive surfaces and said second surface faces the other of said electrically conductive surfaces; and
c) bringing said electrically conductive surfaces in proximity to one another so as to cause the particles on said first surface to break the oxide film on said one electrically conductive surface and to partially penetrate said one electrically conductive surface, and cause the particles on said second surface to break the oxide film on said other electrically conductive surface and to partially penetrate said other electrically conductive surface, whereby said electrical conductivity is established through the particles of said first and second layers and said electrically conductive body.

23. A method according to claim 22, wherein said particles have an average particle size ranging from about 5 μm to about 150 μm.

24. A method according to claim 22 or 23, wherein said oxidation-resistant electrically conductive material is selected from the group consisting of tungsten, tungsten carbide, titanium diboride hardened steel and beryllium-copper alloy.

25. A method according to claim 24, wherein said oxidation-resistant electrically conductive material is tungsten carbide.

26. A method according to any one of claims 22 to 25, wherein the body of said electrical bridging member is formed of a metal selected from the group consisting of Cu, Al, Au, Ag, Fe, Pd, Co, Ni, Ti, Mg, Zn, Sn, Ru and Cd.

27. A method according to claim 26, wherein said body is in the form of a foil, and wherein the particles of said first and second layers partially penetrate said foil.

28. A method according to any one of claims 22 to 25, wherein the body of said electrical bridging member is formed of a metal or metal alloy matrix having dispersed therein particles of said oxidation-resistant electrically conductive material, the dispersed particles having said average particle size.

29. A method according to claim 28, wherein said matrix comprises a metal selected from the group consisting of Cu, Fe, Al, Ag, Pd, Ni, Au, Co, Ti, Mg, Zn, Sn, Ru and Cd.

30. An electrical bridging material in the form of a non-adhesive dispersion for use in establishing electrical conductivity between two electrically conductive surfaces, at least one of said surfaces being covered with an oxide film, said dispersion containing particles of an oxidation-resistant electrically conductive material and a dispersing medium, said particles having an average particle size ranging from about 0.1 μm to about 5 mm.

31. A bridging material according to claim 30, wherein said particles have an average particle size ranging from about 5 μm to about 150 μm.

32. A bridging material according to claim 30 or 31, wherein said oxidation-resistant electrically conductive material is selected from the group consisting of tungsten, tungsten carbide, titanium diboride hardened steel and beryllium-copper alloy.

33. A bridging material according to claim 32, wherein said oxidation-resistant electrically conductive material is tungsten carbide.

34. A bridging material according to any one of claims 30 to 33, wherein said dispersing medium comprises a grease selected from the group consisting of petroleum-based greases and silicone-based greases.

35. A bridging material according to claim 34, wherein said grease is a silicone-based grease formed of polydimethylsiloxane having a viscosity between 100 and 100,000 cSt at 25° C., in admixture with a thickening agent.

36. A bridging material according to claim 35, said silicone-based grease comprises 90 to 97 weight % of polydimethylsiloxane having a viscosity between 100 and 1,000 cSt at 25° C., and 3 to 10 weight % of thickening agent.

37. A bridging material according to claim 36, wherein said silicone-based grease comprises about 95 weight % of polydimethylsiloxane having a viscosity of about 1,000 cSt at 25° C., and about 5 weight % of thickening agent, and wherein said thickening agent is fumed silica.

38. A bridging material according to any one of claims 34 to 37, wherein said dispersion contains 5 to 55 weight % of said particles and 45 to 95 weight % of said grease.

39. A bridging material according to claim 38, wherein said dispersion contains 30 weight % of said particles and 70 weight % of said grease.

40. An electrical bridging member for use in establishing electrical conductivity between two electrically conductive surfaces, at least one of said surfaces being coated with an oxide film, said bridging member having a non-adhering electrically conductive body, first and second surfaces facing opposite directions, and a first layer of particles on said first surface, said particles being formed of an oxidation-resistant electrically conductive material and having an average particle size ranging from about 0.1 μm to about 5 mm.

41. A bridging member according to claim 40, wherein said particles have an average particle size ranging from about 5 μm to about 150 μm.

42. A bridging member according to claim 40 or 41, wherein said oxidation-resistant electrically conductive material is selected from the group consisting of tungsten, tungsten carbide, titanium diboride hardened steel and beryllium-copper alloy.

43. A bridging member according to claim 42, wherein said oxidation-resistant electrically conductive material is tungsten carbide.

44. A bridging member according to any one of claims 40 to 43, wherein said body is formed of a metal selected from the group consisting of Cu, Al, Au, Ag, Fe, Pd, Co, Ni, Ti, Mg, Zn, Sn, Ru and Cd.

45. A bridging member according to claim 44, wherein said body is in the form of a foil, and wherein said particles partially penetrate said foil.

46. A bridging member according to claim 40, further including a second layer of said particles on said second surface.

47. A bridging member according to claim 46, wherein said particles have an average particle size ranging from about 5 μm to about 150 μm.

48. A bridging member according to claim 46 or 47, wherein said oxidation-resistant electrically conductive material is selected from the group consisting of tungsten, tungsten carbide, titanium diboride hardened steel and beryllium-copper alloy.

49. A bridging member according to claim 48, wherein said oxidation-resistant electrically conductive material comprises tungsten carbide.

50. A bridging member according to any one of claims 46 to 49, wherein said body is formed of a metal selected from the group consisting of Cu, Al, Au, Ag, Fe, Pd, Co, Ni, Ti, Mg, Zn, Sn, Ru and Cd.

51. A bridging member according to claim 50, wherein said body is in the form of a foil, and wherein the particles of said first and second layers partially penetrate said foil.

52. A bridging member according to claim 46, wherein the body is formed of a metal or metal alloy matrix having dispersed therein particles of said oxidation-resistant electrically conductive material, the dispersed particles having said average particle size.

53. A bridging member according to claim 52, wherein said particles have an average particle size ranging from about 5 μm to about 150 μm.

54. A bridging member according to claim 52 or 53, wherein said oxidation-resistant electrically conductive material is selected from the group consisting of tungsten, tungsten carbide, titanium diboride hardened steel and beryllium-copper alloy.

55. A bridging member according to claim 54, wherein said oxidation-resistant electrically conductive material is tungsten carbide.

56. A bridging member according to any one of claims 52 to 55, wherein said matrix comprises a metal selected from the group consisting of Cu, Fe, Al, Ag, Pd, Ni, Au, Co, Ti, Mg, Zn, Sn, Ru and Cd.
